(19) United States
(12) Patent Application Publication
(10) Pub. No.: US 2011/0002065 A1
(43) Pub. Date: Jan. 6, 2011

(54) RECORDING HEADS WITH EMBEDDED TAPE GUIDES AND MAGNETIC MEDIA MADE BY SUCH RECORDING HEADS

(76) Inventors: Matthew P. Dugas, St. Paul, MN (US); Gregory Lawrence Wagner, Arden Hills, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/841,788

(22) Filed: Jul. 22, 2010

Related U.S. Application Data
(63) Continuation of application No. PCT/US2009/031798, filed on Jan. 23, 2009.
(60) Provisional application No. 61/022,872, filed on Jan. 23, 2008.

(51) Int. Cl. G11B 5/584

(52) U.S. Cl. 360/77.12; G9B/5.203

(57) ABSTRACT

The present disclosure relates to apparatus and methods for recording heads with tape guides, including embedded tape guides. In one embodiment a magnetic recording head includes a contour modified to include a tape guide. The tape guide may include compliant or non-compliant edge guides. In another embodiment, a magnetic recording head includes a contour configured to impart a lateral force on the surface of tape streaming over the head. The head may include air-bleed slots, air skiving edges, non-symmetrical head surfaces, specific contour topographies, negative pressure elements, or any combination thereof. The streaming tape may be held referenced against the a tape guide by the lateral force. In a further embodiment, the present disclosure relates to magnetic tape wherein the written-in lateral tape motion is substantially eliminated.

### CROSS-REFERENCE TO RELATED APPLICATIONS

This application is a continuation of International Patent Application No. PCT/US2009/031798 filed Jan. 23, 2009, which claims priority to U.S. Ser. No. 61/022,872 filed Jan. 23, 2008, the contents of each of which are herein incorporated by reference.

### FIELD OF THE INVENTION

The present disclosure relates to apparatus and methods for recording heads, including magnetic recording heads. Particularly, the present disclosure relates to apparatus and methods for magnetic recording heads with tape guides. More particularly, the present disclosure relates to apparatus and methods for magnetic recording heads with embedded tape guides.

### BACKGROUND OF THE INVENTION

Tape edge guiding is an important issue in high density recording using flexible tape. Optimization of the lateral stability of the tape is desirable in order to go to higher track densities.

In the magnetic tape data storage industry, data is stored as a sequential stream of magnetic transitions, written in a series of adjacent tracks down the length of tape. A track may also be referred to herein as a band. Magnetic write and read heads follow the bands of data down the length of tape, writing and reading the information contained in the magnetic transitions.

When the magnetic heads read and write the data of a chosen band, it is important that the heads not read from, or write data on, adjacent bands. In read-back operations, failure to stay on the chosen track or band may result in contaminated data from detection of adjacent band transitions. In writing operations, failure to stay on the chosen track or band, may result in the adjacent band data being overwritten, and hence data loss.

As magnetic tape is a flexible media, many degrees of motion and motion characteristics are present in the tape while it is streaming over the read/write heads during recording operations. Some of these motions consist of in-plane lateral motion modes. Motion of the tape surface perpendicular to the tape streaming direction may be referred to herein as Lateral Tape Motion (LTM). LTM includes motion of the tape in the direction of the adjacent data bands, and hence may be undesirable. This motion is a primary source of tracking errors during recording operations.

LTM can be roughly thought of in two categories, written-in and read-back. Written-in LTM is the LTM written in during magnetic writing (formatting) of the servo band. As the tape streams over the servo formatting magnetic head, the LTM characteristic of the tape path is written into the servo band on tape. During read back operations, the detected LTM consists of this written-in portion, and the portion produced by the read-back tape path. In general, the read-back tape path is of significantly lower quality than the servo formatting tape path.

In current generations of magnetic tape, the width of the data bands and the distance between adjacent data bands are sufficiently small. Typically, LTM and other undesirable motions of the tape must be compensated for to allow proper tracking during read/write operations. This can be accomplished through active servo-following of the chosen band, e.g., utilizing servo bands.

Magnetic servo bands are typically written into the media in the tape manufacturer production facility. These servo bands are written into the tape in specific and well controlled positions on the tape. The type of servo bands used depends on the specific tape format. A typical format is Linear Tape Open (LTO).

There are usually multiple servo bands formatted into the tape. These bands are designed to functionally span the tape width, and are generally not over-written while the tape is in use. Servo bands are the system metric used for track following, and hence should be written as accurately as possible. Servo bands are sensed by a magnetic read head while the tape is streaming. By actively monitoring the position and movement of these servo bands during streaming, the read/write data heads can be dynamically positioned to a desired location.

A system used to stream tape over a magnetic read/write head may be referred to herein as a tape transport, and are known in the art. The course the tape follows while streaming through a tape transport may be referred to herein as a tape path.

Motion of the tape while streaming through any tape transport mechanism is a characteristic of the particular tape path used. Throughout the magnetic tape data storage industry, a significant amount of development occurs for a given tape path. This development typically focuses on controlling the tapes many modes of motion and removing unwanted motion. Differing degrees of undesirable motion can be present along differing sections of the tape path. The minimization of LTM can be a significant design criteria for a given tape path.

The motion of the tape can be controlled through the implementation of tape guides. The tape guides, used to control the position and motion of the tape as it moves along portions of the tape path, can be designed as a component of the system. Some types of tape guides are currently used in the industry. The most common family of guides are tape edge guides. This family of guides acts on the tape edge, either as a barrier/constraint, or as a reference edge/datum.

Tape guiding systems are present in the user tape drive and tape guiding systems and in the formatting of the tape at the tape manufacturer. While both uses are envisioned to be improved upon by the embodiments of the present disclosure, the embodiments of the present disclosure will generally be explained with exemplary embodiments of formatting of a tape at the tape manufacturing facility.

FIG. 1 illustrates an exemplary tape path segment local to a magnetic recording head. Here a tape is shown passing through two bobbins (i.e., guides) and across a recording head. The two bobbins have upper and lower flanges which contact the tape edge and constrain the motion of the tape. These bobbins and their flanges act as a barrier/constraint type of edge guide. These bobbins may be stationary, or may rotate depending on the tape path design. The distance from when the tape leaves contact with one bobbin and enters contact with the next is referred to herein as a free span.

IBM has developed a fixed lower edge guide coupled to a forcing or compliant upper edge guide, as illustrated in FIG. 2. The edge guide assembly may be used as a Field Replaceable Unit (FRU) tape path. The FRU is a relatively large mechanism that contains the head in a head mount and a tape path adjacent to the head. An important operating mechanism of the IBM FRU is a ceramic bottom datum, which the tape edge rides against. The tape is referenced upon this datum by spring loaded ceramic buttons. This long-span tape guide system contains .a large input span where the tape is coming into the head region and a large output span where the tape leaves the head region.

However, one limitation of current tape guiding systems, independent of the type of guiding that is used, is the existence of a guide-free span across the head region. In general, the longer the free span of tape in a tape path, the larger the amplitude of undesirable motions, such as LTM. In critical regions of the tape path, such as the head region, it may therefore be desirable to limit the free span lengths. The free span may be minimized with such techniques referred to herein as close edge guiding. In such a system, for example a servo format system, the tape guides are brought as close to the read/write head as practical.

The section of the tape path exemplarily focused on herein is the active path length associated with encoding of the servo pattern into the media in a servo formatting tape path. The characteristics of the tape path, local to the servo formatting region, may be a primary concern for limiting written-in LTM. By limiting the free span of tape across the servo formatting head, it can be possible to limit the amplitude of the undesirable modes of tape motion. For this reason, the systems responsible for servo formatting are sometimes designed with edge guides in close proximity to the servo formatting magnetic head. However, the region of tape path designated for the servo formatting head constitutes an operational free tape span.

Thus, there is a need in the art for improved magnetic recording heads that guide streaming tape across the contour of the head. Additionally, there is a need in the art for magnetic recording heads that minimize the free span across the contour of the head. There is a need in the art for magnetic recording heads with tape guides.

### BRIEF SUMMARY OF THE INVENTION

The present disclosure, in one embodiment, relates to a magnetic recording head having a contour modified to include a tape guide. The tape guide may include a single edge, non-compliant edge guide, a double edge, non-compliant edge guide, a single edge, compliant edge guide, a double edge, compliant tape guide, or a combination of a single edge, non-compliant edge guide and single edge, compliant edge guide.

The present disclosure, in another embodiment, relates to a magnetic recording head having a contour that is configured to impart a lateral force on the surface of tape streaming over the head. To impart the lateral force, the head may include air-bleed slots that are non-perpendicular to the streaming direction of the tape, air skiving edges that are non-perpendicular to the streaming direction of the tape, non-symmetrical head surfaces, specific contour topographies, strategically located negative pressure elements, or any combination thereof. The magnetic recording head may further include a tape edge guide.

The present disclosure, in yet another embodiment, relates to a method of making a magnetic recording head. The method includes providing a tape edge guide on a contour of a magnetic head. The method may also include providing air-bleed slots on the contour of the head configured to impart a lateral force on the surface of tape streaming over the head.

The present disclosure, in one embodiment, relates to a magnetic recording head having a tape bearing surface comprising means for guiding streaming tape over the tape bearing surface.

The present disclosure, in still a further embodiment, relates to a method of formatting magnetic tape. The method includes streaming magnetic tape over a tape bearing surface of a magnetic recording head, the magnetic recording head comprising a tape edge guide.

The present disclosure, in one embodiment, relates to magnetic media having magnetic transitions. The magnetic transitions are written on the tape while the magnetic tape is guided over the contour of a magnetic recording head. The contour of the magnetic recording head is modified to include a tape edge guide. In other words, in some embodiments, the magnetic media is made by streaming the magnetic media over a tape bearing surface of a magnetic recording head, the magnetic recording head comprising a tape edge guide.

The present disclosure, in another embodiment, relates to a magnetic drive system including a tape transport, a tape path, and a magnetic recording head in the tape path. The contour of the head is modified to include a tape guide. The magnetic recording head may be a data read/write head or a servo read/write head.

The present disclosure, in yet another embodiment, relates to magnetic tape having substantially eliminated written-in lateral tape motion.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is perspective view of an exemplary tape path segment local to a magnetic recording head.

FIG. 2 is a perspective view of a field replaceable unit having a fixed lower tape edge guide coupled to a forcing or compliant upper tape edge guide.

FIG. 3 is an overhead view of tape streaming over a tape head.

FIG. 4 is an overhead view of tape streaming over a tape head having a tape edge guide in accordance with one embodiment of the present disclosure.

FIG. 5 is an overhead view of tape streaming over a tape head having a tape edge guide that extends beyond the tape head in accordance with another embodiment of the present disclosure.

FIG. 6 is a perspective view of tape streaming over a tape head having a tape edge guide on each side of the tape in accordance with a further embodiment of the present disclosure.

FIG. 7 is an overhead view of tape streaming over a tape head having a tape edge guide on each side of the tape that extends beyond the tape head in accordance with another embodiment of the present disclosure.

FIG. 8 is an overhead view of tape streaming over a tape head having a tape edge guide in accordance with yet another embodiment of the present disclosure, wherein the head contour further comprises angled air-bleed slots.

FIG. 9 is an overhead view of tape streaming over a tape head having a tape edge guide in accordance with an embodiment of the present disclosure, wherein the head contour further comprises angled air-bleed slots at the tape entrance side of the tape head.

### DETAILED DESCRIPTION

The present disclosure relates to novel and advantageous apparatus and methods for recording heads, including magnetic recording heads. Particularly, the present disclosure relates to apparatus and methods for magnetic recording heads with tape guides. More particularly, the present disclosure relates to apparatus and methods for magnetic recording heads with embedded tape guides. The embodiments of the present disclosure may utilize tape edge guides, embedded into the head contour, to minimize the amplitude of unwanted lateral motion. A tape edge guide may be designed into the tape head contour as an integral part of the tape head. This may allow the integration of tape edge guiding techniques into intimate proximity to a servo formatting region. In addition, it may allow for minimization of the effective free tape span, local to the servo formatting process, and can add design flexibility to the tape path. The embodiments of the present disclosure may reduce, substantially reduce, or substantially eliminate the written-in component of LTM and decrease the tracking errors in servo-following operations for data writing and recovery.

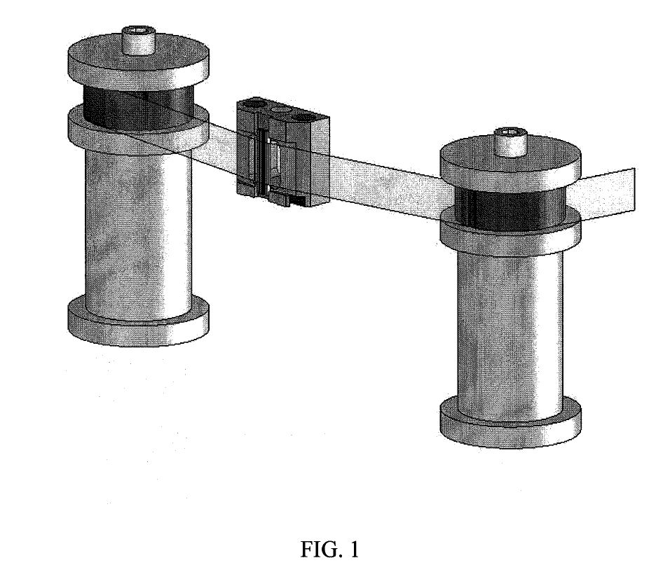

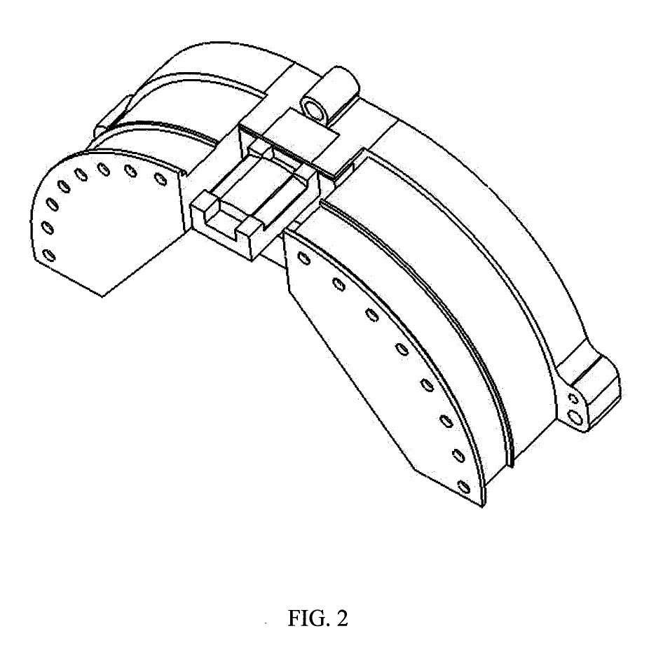

There are many types of edge guides that can be used in tape paths. Some guides are discussed above and illustrated in FIGS. 1 and 2. The most typical guides may include compliant or non-compliant tape edge guides. Compliant edge guides may also include or be referred to as “soft” edge guides. The bobbins and flanges illustrated in FIG. 1 are an example of non-compliant tape edge guides. The IBM® FRU illustrated in FIG. 2 is an example of a system with a non-compliant guide (i.e., reference edge/datum) and a compliant edge guide (e.g., spring loaded ceramic buttons). The various embodiments of the present disclosure can include any type of compliant or non-compliant tape edge guide. Additionally, it need not be necessary that the guide principal be tape edge guiding. For example, contours can be designed which result in a preferential lateral force being produced on the tape as a result of head to tape interaction as it passes over the servo formatting head. Such preferential loading may further be utilized to reference the head against a guide or datum, as further described in detail below.

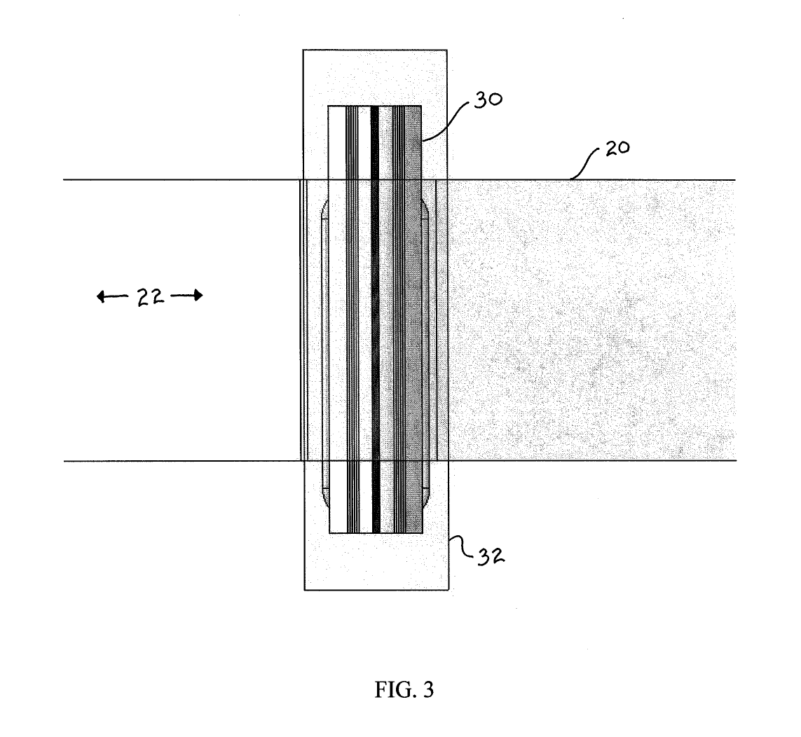

FIG. 3 illustrates tape 20 streaming over a servo formatting head 30 without intrinsic guides built into or added to the contour. The head 30 is shown in an exemplary head mount or head mounting assembly 32 that may be appropriate for integration into a tape path 22. The head 30, as illustrated in FIG. 3, may include one or more write patterns or gap patterns for writing a servo band on the tape 20 as the tape 20 streams over the head 30. The head 30 may include any suitable number of write patterns. The write patterns may be timing-based servo patterns or amplitude-based servo patterns. Each write pattern may include a suitable number of write gaps. In some embodiments, a write pattern may include two write gaps. The write gaps may both be slanted, or non-orthogonal to the direction of the streaming tape, one may be slanted and one may be orthogonal to the direction of the streaming tape, etc. It is recognized that any suitable configuration of write gaps may be used with the embodiments of the present disclosure, including write gap patterns such as |, \ / (e.g., ‘V’-pattern), / \ (e.g., inverted ‘V’-pattern), / |, | \, | \ | (e.g., ‘N’-pattern), or any variations thereof, etc.

The head 30 may be a head such as that described in U.S. Pat. No. 6,678,116, issued Jan. 13, 2004, and titled “Thin-film Magnetic Recording Head Having a Timing-Based Gap Pattern for Writing a Servo Track on Magnetic Media,” U.S. Pat. No. 6,496,328, issued Dec. 17, 2002, and titled “Low Inductance, Ferrite Sub-Gap Substrate Structure for Surface Film Magnetic Recording Heads,” U.S. patent application Ser. No. 11/017,529, filed Dec. 20, 2004, published as U.S. Publ. No. 2005/0157422, and titled “Timing-Based Servo Verify Head and Method Thereof,” and U.S. patent application Ser. No. 11/120,640, filed May 3, 2005, published as U.S. Publ. No. 2005/0254170, and titled “Integrated Thin Film Subgap Subpole Structure for Arbitrary Gap Pattern Magnetic Recording Heads and Method of Making the Same,” each of which is hereby incorporated by reference herein. In other embodiments, the head 30 may be any suitable recording head.

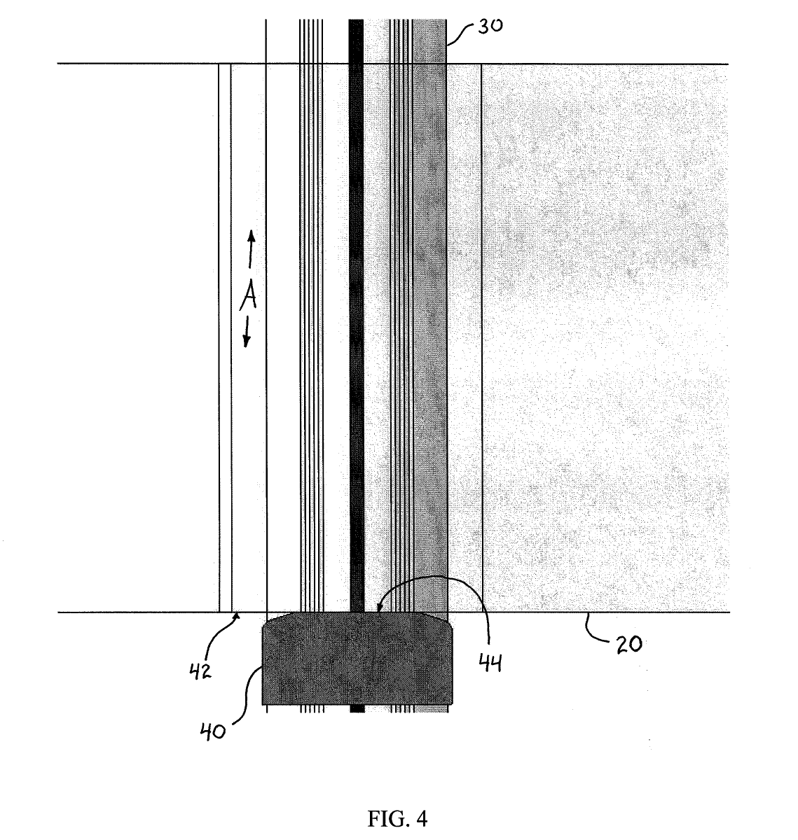

In one embodiment of the present disclosure, illustrated in FIG. 4, an edge guide 40 may be added to an upper surface of one side of the head 30. Edge guide 40 may be a compliant edge guide or non-compliant, stationary edge guide. A guide surface 44 of the edge guide 40 may contact the tape edge 42. Lateral motion, shown as arrow A, may be constrained by contact between the guide surface 44 and the tape edge 42. As the streaming tape 20 contacts the guide surface 44, it may be prevented from further lateral motion. In some embodiments, lateral motion of the streaming tape 20 may be reduced, substantially reduced, or substantially eliminated.

In one embodiment, the edge guide 40 may be an integral component of the contour of the tape head 30 and may be manufactured integrally and substantially simultaneously with the tape head 30. Thus, the edge guide 40 may be manufactured using deposition techniques, lithographic techniques, or any other suitable method, including each of the methods described in U.S. Pat. No. 6,678,116, U.S. Pat. No. 6,496,328, U.S. patent application Ser. No. 11/017,529, and U.S. patent application Ser. No. 11/120,640, each of which was previously incorporated by reference herein, or any other suitable method of manufacturing the edge guide 40 integrally with the tape head 30. In other embodiments, the edge guide 40 may be added to the tape head 30 subsequent manufacture of the tape head 30. That is, the edge guide 40 may be manufactured independently from the head 30. The edge guide 40 may then be bonded, adhesively applied, or otherwise combined with, or accepted by, the head 30.

During streaming, the tape 20 may be held under tension, and lateral or other undesirable motions can be partially reduced by existing guides in the tape path, such as those described previously with respect to FIGS. 1 and 2. A formatting head 30 with a built-in edge guide 40, as shown in FIG. 4, may be further aligned into the tape path 22, such that the tape tension and existing guides allow the tape 20 to be loaded against the guide surface 44 of the edge guide 40 of the head 30. In this manner, the built-in edge guide 40 may further constrain the undesirable modes of motion of the tape 20 across the head region. Therefore, LTM and the effective free span length of the tape local to generally critical regions of servo formatting may be reduced, substantially reduced, or substantially eliminated using the embodiments of the present disclosure.

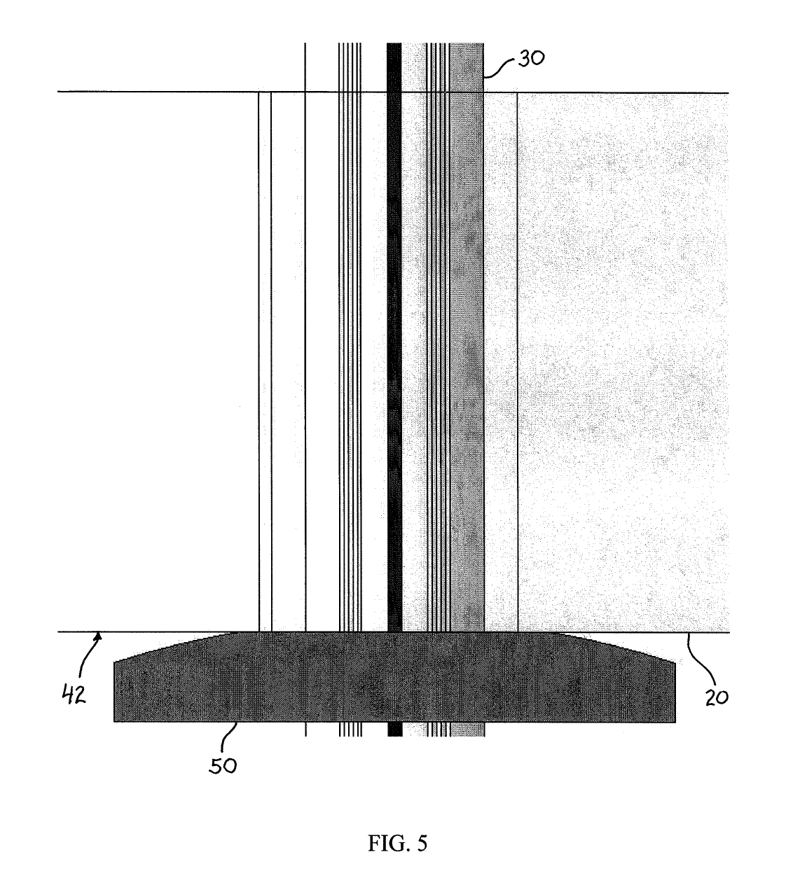

FIG. 5 illustrates another embodiment of a tape guide of the present disclosure, wherein the length of the edge guide 50 (e.g., streaming direction) may be extended beyond the immediate contour of the head 30. In certain embodiments, this may allow the head 30 to be placed in a reference mounting assembly, and the built-in edge guide 50 may be lengthened to span the width of the head and the width of the head mount. In alternative embodiments, the length of the edge guide 50 may be extended to any suitable length beyond the width of the head 30. In yet other embodiments, the length of the edge guide 50 may be shorter than the width of the head 30.

Alignment of a built-in, or contour, edge guide into the tape path may be held to high or very high tolerances. Extending the head guide to include the span of the head mount may allow the precision of guide alignment to the tape edge 42 to be referenced to the head mount in a high precision mounting operation. This can have several advantages. One advantage may include that the head mount can contain high precision locating surfaces to allow easy alignment in the tape path. Another advantage, is that the alignment of the contour edge guide to the head mount reference surfaces can be done outside the production facility using accurate tooling and metrology to ensure proper alignment. This may increase the ease and precision to which the head and contour edge guide can be integrated into the tape path.

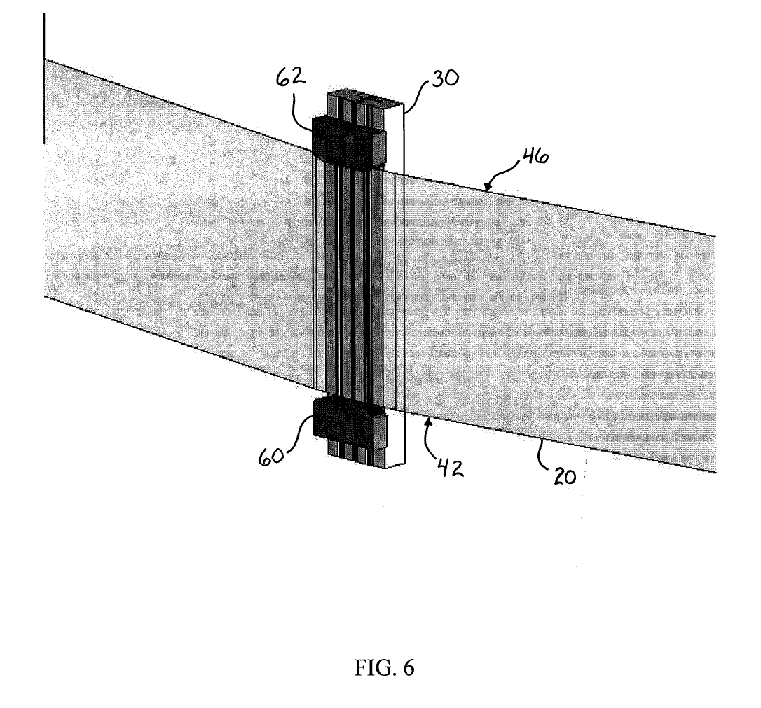

In another embodiment, illustrated in FIG. 6, two edge guides 60, 62 may be provided. The edge guides 60, 62 may be provided such that there is an edge guide on each tape edge 42, 46. In such an embodiment, the edge guides 60, 62 may work together to constrain the LTM and other undesirable modes of motion. The edge guides 60, 62 can be compliant edge guides, non-compliant edge guides, or any suitable combination thereof. In embodiments where edge guides 60, 62 are both non-compliant guides, the tape 20 could be constrained to move only between two interior guided edges of the edge guides 60, 62. In some embodiments, one edge guide, e.g., 60, could be a non-compliant edge guide that can serve as a reference edge/datum, and the other edge guide, e.g., 62, could be a compliant edge guide, providing a slight lateral force to reference the tape against the datum edge.

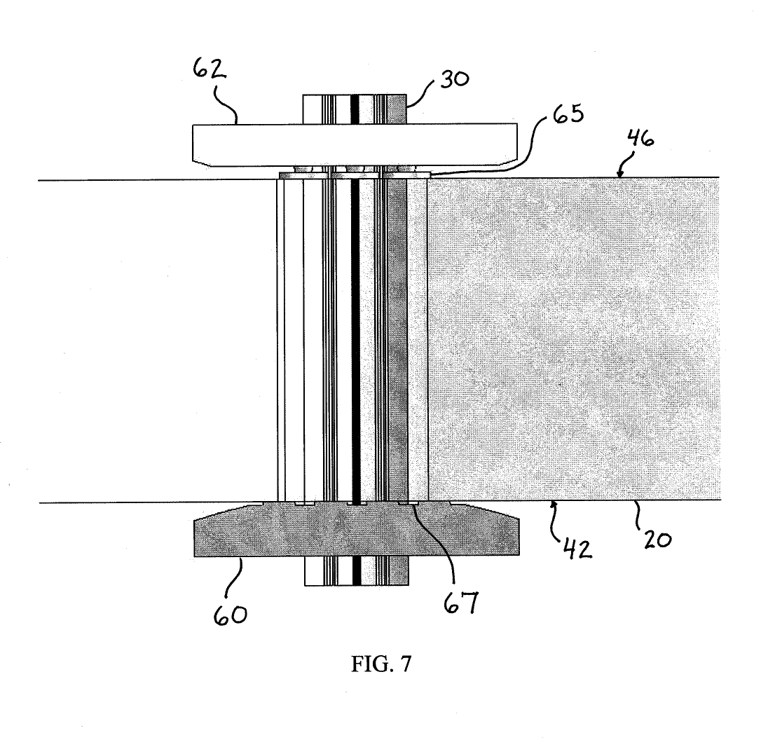

The length of the edge guides 60, 62 may be extended to any suitable length beyond the width of the head 30. In yet other embodiments, the length of the edge guides 60, 62 may be shorter than the width of the head 30. Additionally, the length of the edge guide 60 may be different than the edge guide 62. For example, the length of edge guide 60 may be substantially the width of the head 30 while the length of edge guide 62 may be substantially the width of a head mount. FIG. 7 illustrates an embodiment of edge guides 60, 62, wherein the edge guides 60, 62 may be extended outside the immediate head contour. In FIG. 7, the upper guide 62 is illustrated as a compliant guide having spring-loaded ceramic buttons or members 65. The compliant ceramic members 65 can provide a relatively soft restoring force that holds the bottom edge of the tape 20 to the lower edge guide 60. In further embodiments, an edge guide, such as the lower edge guide 60 in FIG. 7, may be provided with slots 67 to reduce friction. Other types of compliant and non-compliant guides are considered within the spirit and scope of the disclosure.

In some embodiments, pushing on one edge of tape with a compliant edge guide to reference the opposite edge of the tape can sometimes cause undesirable tension gradients, as well as ripple and buckling of the tape 20. Tension gradients can be undesirable, as they may affect the Head-to-Tape Interface (HTI), and hence the read/write performance of the system. Additionally, a tape edge, in some embodiments, may be used as a streaming reference throughout the tape path. Therefore, tape edge damage can negatively affect the motion characteristics of the tape and can increase the native LTM. Current generations of magnetic tape can be on the order of 5-8 um thick and over 12.5 mm wide. As tape is generally flexible, such a thickness to width ratio can mean that pushing on a tape edge, which is dynamically streaming past, should be done with great care and, in some embodiments, can lead to undesirable edge damage. Thus, in some embodiments, in order to reference the tape against an edge guide with suitable care, it may be desirable to apply a lateral force to the tape uniformly over the entire tape surface. This can minimize potential tension gradients and prevent the occurrence of tape edge damage.

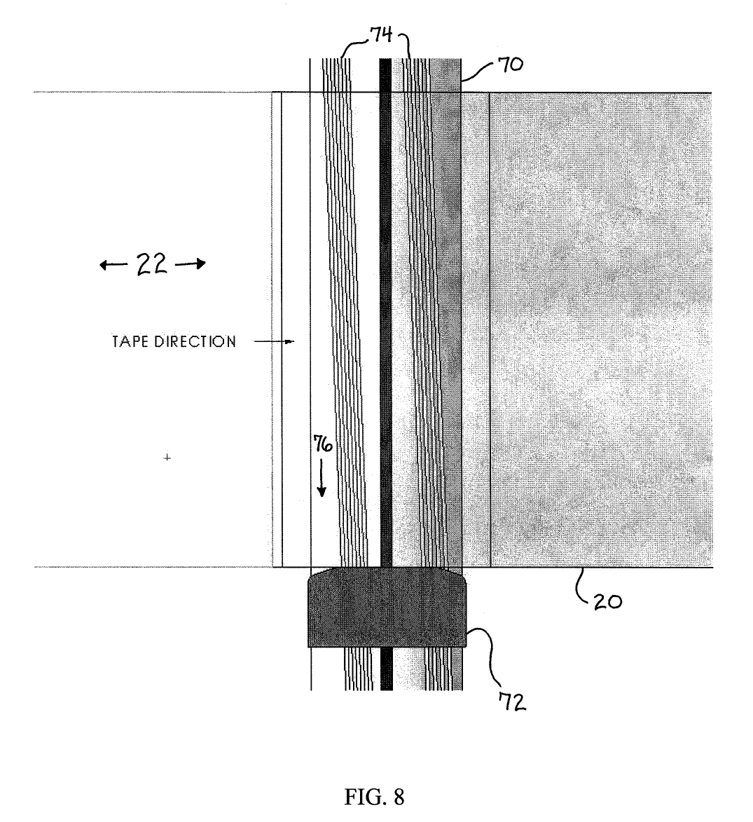

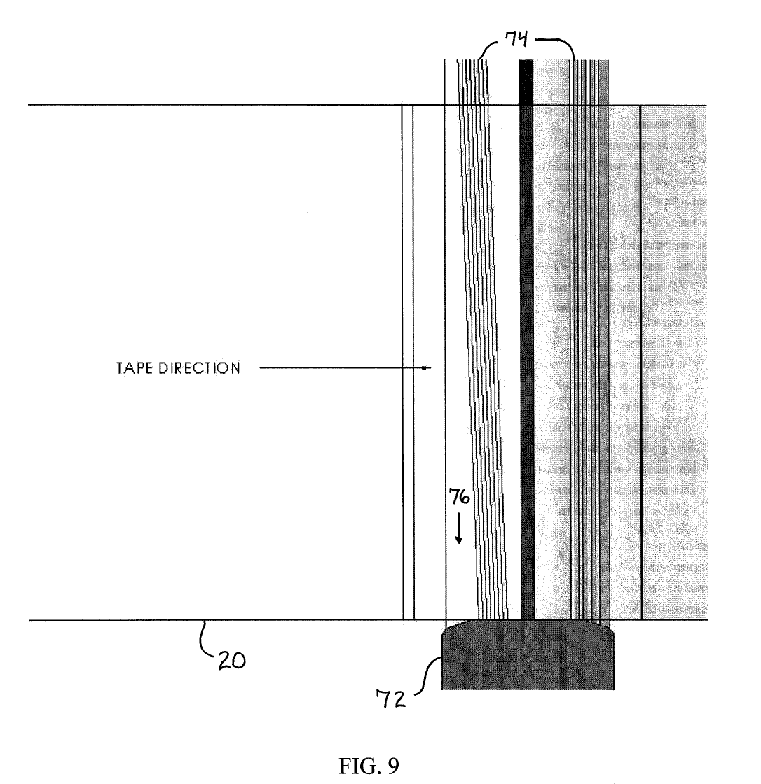

FIGS. 8 and 9 illustrate alternative embodiments of the present disclosure that may solve the above identified problems. A servo formatting head 70 with a built-in edge guide 72, is illustrated in FIG. 8. The contour of the servo formatting head 70 can be designed to produce a specific HTI in the tape path 22. For example, the contour of the head 70, in some embodiments, may be substantially a radius, with air-bleed slots 74 at the tape entrance and exit positions of the head 70. As the tape 20 contacts the head contour, the air-bleed slots 74 may remove the air being pulled along with the tape 20 and pull the tape 20 into close proximity to the head surface. The air-bleed slots 74 may scrape the air off the tape surface. Generally, the tape 20 may enter the head contour and become pulled down to the head surface through interaction with the air-bleed slots 74. The slots 74 may normally be cut perpendicular to the tape streaming direction, as illustrated in FIGS. 3-7, to prevent any tape steering effects by the slots. However, in some embodiments, the head 70 can be designed such that the contour of the head 70 imparts a lateral force 76 on a surface of the tape 20. For example, the air-bleed slots 74 may be cut at a non-perpendicular angle to the tape streaming direction. By placing the air-scrubbing, air-bleed slots 74 of the head contour at non-perpendicular angles to the tape streaming direction, a net mechanical lateral force 76 may be applied to the tape 20. The lateral force 76 may be applied uniformly over the surface of the tape 20, minimizing undesirable tension gradients and edge effects. In such embodiments, the tape 20 may be held referenced against the contour edge guide 72 by the net lateral force 76 applied to the surface of the tape 20.

In alternative embodiments, other features provided on the head 70 may be used to impart the lateral force 76, including but not limited to, air skiving edges that are non-perpendicular to the tape streaming direction, strategically located negative pressure elements, etc.

In other embodiments, the lateral force 76 may be imparted by characteristics of the head 70 itself, such as but not limited to, non-symmetrical head surfaces, specific contour topographies, etc. Similarly, any combination of features or characteristics may be provided to impart the lateral force 76. That is, it need not be necessary for the lateral force 76 to be a result of angled air-bleed slots, skiving edges, or surfaces. Any suitable contour geometry, surface, or other quality or characteristic that produces a net lateral force 76 could be sufficient.

FIG. 9 illustrates another embodiment of such an approach, wherein, the angled air-bleed slots, or other feature or characteristic of the head 70 may be present on one side of the head contour. The location, dimensions, and orientation of the slots 74 or features may depend on the particular tape path, media, and media velocity used, and any suitable location, dimensions, and orientation of the air-bleed slots 74 may be used with the embodiments of the present disclosure. The embodiments of FIGS. 8 and 9 may further minimize or substantially eliminate both LTM and tape edge damage during formatting operations.

Although the various embodiments of the present disclosure have been described with reference to preferred embodiments, persons skilled in the art will recognize that changes may be made in form and detail without departing from the spirit and scope of the present disclosure.

We claim:

1. A magnetic recording head, wherein the head includes a tape guide.

2. The magnetic recording head of claim 1, wherein the tape guide is bonded to the head.

3. The magnetic recording head of claim 1, wherein the tape guide is embedded into the body of the head.

4. The magnetic recording head of claim 1, wherein the tape guide is affixed proximate the surface of the head.

5. The magnetic recording head of claim 1, wherein the tape guide comprises a non-compliant edge guide for guiding a first edge of magnetic tape.

6. The magnetic recording head of claim 1, wherein the tape guide comprises a compliant edge guide for guiding a first edge of magnetic tape.

7. The magnetic recording head of claim 1, wherein the tape guide comprises a non-compliant edge guide and a compliant edge guide for guiding of a magnetic tape.

8. The magnetic recording head of claim 1, wherein the tape guide comprises a first and second compliant edge guide for guiding of a magnetic tape.

9. A magnetic recording head, wherein a tape guide is located substantially adjacent to a tape bearing surface of the head.

10. A magnetic recording head, where the head is configured to impart a lateral force on a surface tape streaming over the head.

11. The magnetic recording head of claim 10, wherein the lateral force is a result of air-bleed slots that are non-perpendicular to the streaming direction of the tape.

12. The magnetic recording head of claim 10, wherein the lateral force is a result of air skiving edges that are non-perpendicular to the streaming direction of the tape.

13. The magnetic recording head of claim 10, wherein the lateral force is a result of a non-symmetrical head surfaces.

14. The magnetic recording head of claim 10, wherein the lateral force is a result of the head contour topography.

15. The magnetic recording head of claim 10, wherein the lateral force is a result of strategically located negative pressure elements.

16. The magnetic recording head of claim 10, further comprising a tape guide.

17. The magnetic recording head of claim 16, wherein the tape guide comprises a non-compliant edge guide for guiding a first edge of magnetic tape.

18. The magnetic recording head of claim 16, wherein the tape guide comprises a compliant edge guide for guiding a first edge of magnetic tape.

19. The magnetic recording head of claim 16, wherein the tape guide comprises a non-compliant edge guide and a compliant edge guide for guiding of a magnetic tape.

20. The magnetic recording head of claim 16, wherein the tape guide comprises a first and second compliant edge guide for guiding of a magnetic tape.

21. A magnetic recording head, comprising a tape bearing surface comprising means for guiding streaming tape over the tape bearing surface.

22. A method of formatting magnetic tape, comprising streaming magnetic tape over a tape bearing surface of a magnetic recording head, the magnetic recording head comprising a tape edge guide.

23. Magnetic media comprising magnetic transitions written on the tape while the magnetic media is guided over a contour of a magnetic recording head, wherein the contour of the magnetic recording head is modified to include a tape edge guide.

24. Magnetic media made by streaming the magnetic media over a tape bearing surface of a magnetic recording head, the magnetic recording head comprising a tape edge guide.

25. A magnetic drive system comprising a tape transport, a tape path, and a magnetic recording head in the tape path, wherein a contour of the head is modified to include a tape guide.

26. The magnetic drive system of claim 25, wherein the magnetic recording head is a data head for reading data from and writing data to one or more data tracks on magnetic media streaming past the head.

27. The magnetic drive system of claim 25, wherein the magnetic recording head is a servo head for reading servo data from or writing servo data to one or more servo tracks on magnetic media streaming past the head.

28. Magnetic tape wherein the written-in lateral tape motion is substantially eliminated.
